(19) United States
(12) Patent Application Publication
(10) Pub. No.: US 2019/0245935 A1
(43) Pub. Date: Aug. 8, 2019

(54) METHODS AND APPARATUS TO CREATE OPPORTUNISTIC NETWORK OF IOT COLLABORATION AGENTS TO COLLECT DATA FROM MOBILE DEVICES

(71) Applicant: The Nielsen Company (US), LLC, New York, NY (US)

(72) Inventor: Teresa Van Dusen, Richardson, TX (US)

(21) Appl. No.: 15/891,349

(22) Filed: Feb. 7, 2018

(51) Int. Cl. H04L 29/08; H04N 21/442

(52) U.S. Cl. CPC H04L 67/22; H04L 67/20; H04L 67/125; H04N 21/44222

(57) ABSTRACT

Methods, apparatus, systems and articles of manufacture to create an opportunistic network of IoT collaboration agents to collect data from mobile devices are disclosed. A first device transmits a request to a second device for resource information, determines a first portion of media monitoring data assigned to the first device and a second portion of the media monitoring data assigned to a second device according to a monitoring data allocation, the monitoring data allocation based on the media monitoring data and the resource information, transmits the second portion to the second device to be processed and transmitted to a collection facility, processes the first portion at the first device, and transmits the processed first portion to the collection facility to be combined with the processed second portion.

### FIELD OF THE DISCLOSURE

This disclosure relates generally to media monitoring data collection, and, more particularly, to methods and apparatus to create an opportunistic network of Internet of Things (IoT) collaboration agents to collect data from mobile devices.

### BACKGROUND

In recent years, methods of accessing media have evolved. For example, in the past, Internet media was primarily accessed via computer systems such as desktop and laptop computers. Recently, handheld mobile devices (e.g., smartphones, tablets, etc.) have been introduced that allow users to request and view Internet media. Such handheld mobile devices have been equipped with a capability to stream Internet media, access web sites, and access nearly all other forms of Internet media. Using an audience measurement entity (AME) designed for a mobile device, network traffic generated by the mobile device may be monitored and/or captured. Media monitoring data may be collected and processed at the mobile device by the AME. The media monitoring data is transmitted to a server where it can be stored and reports on usage information can be generated.

### BRIEF DESCRIPTION OF THE DRAWINGS

FIG. 1 is block diagram of an example environment 100 constructed in accordance with the teachings of this disclosure to collect data from mobile devices.

FIG. 2 is a block diagram of an example implementation of the meter of FIG. 1 to implement the examples disclosed herein.

FIG. 3 is a block diagram of an example implementation of the Internet of Things (IoT) device of FIG. 1 to implement the examples disclosed herein.

FIG. 4 is a flow diagram of example machine readable instructions that may be executed to implement the meter of FIG. 1 and/or FIG. 2.

FIG. 5 is a flow diagram of example machine readable instructions that may be executed to implement the IoT device to receive, process, and transmit media monitoring data assigned by the meter 104 of FIGS. 1-3.

FIG. 6 is a flow diagram of example machine readable instructions that may be executed by the example Internet of Things device to acquire and transmit resource information of the IoT device of FIGS. 1-3.

FIG. 7 is a flow diagram of example machine readable instructions that may be executed to implement the example meter of FIGS. 1-3 to recover a forgotten, lost, etc. device identifier.

FIG. 8 is a flow diagram of example machine readable instructions which may be executed to implement the example IoT device of FIGS. 1-3 to store and transmit a mobile device identifier.

FIG. 9 is a flow diagram of example machine readable instructions which may be executed to implement the example collection server of FIGS. 1-3 to receive and combine processed media monitoring data.

FIG. 10 is a flow diagram of example machine readable instructions which may be executed by the example collection server of FIGS. 1-3 to acquire and transmit a device identifier (or any other identifier, such as a panelist identifier, identification marker, etc.) associated with a mobile device.

FIG. 11 is a block diagram of an example processor platform structured to execute machine readable instructions to implement the methods of FIGS. 4 and 7 and/or the example meter of FIGS. 1-3.

FIG. 12 is a block diagram of an example processor platform structured to execute machine readable instructions to implement the methods of FIGS. 5-6 and 8 and/or the example IoT device of FIGS. 1-3.

Wherever possible, the same reference numbers will be used throughout the drawing(s) and accompanying written description to refer to the same or like parts. As used herein, the term “coupled” is defined as connected directly or indirectly (e.g., through one or more intervening structures and/or layers).

### DETAILED DESCRIPTION

Audience measurement entities (AME) desire to gain knowledge on users viewing different types of media. As used herein “media” refers to audio and/or visual (still or moving) content and/or advertisements. Thus, media includes movies, web site content, streaming media, etc. In examples disclosed herein, monitoring data (e.g., media monitoring data) includes, but is not limited to, media identifying data (e.g., media-identifying metadata, codes, signatures, watermarks, and/or other information that may be used to identify presented media), application usage data (e.g., an identifier of an application, a time and/or duration of use of the application, a rating of the application, etc.), and/or user-identifying data (e.g., demographic information, a user identifier, a panelist identifier, a username, etc.).

In some cases, the AME want to monitor media consumption by users on mobile media devices such as, for example, a smartphone, tablets, etc. The AME want to, among other things, monitor exposure to streaming media (e.g., Netflix™ Hulu™ Pandora™, etc.), monitor exposure to advertisements, monitor exposure to web content (e.g., web sites, etc.), determine advertisement effectiveness, determine user behavior, identify purchasing behavior associated with various demographics, and/or gather other useful monitoring information. Some known systems have utilized a meter to monitor media being transmitted to and/or from the monitored mobile media device.

The AME utilize methods and apparatus to monitor media consumption behavior of mobile device users and collect media monitoring data at a central collection facility. In some instances, a meter collects monitoring data, processes the monitoring data, and transmits the data to a central collection facility, such as a collection server. Processing the monitoring data may include extracting information such as embedded codes, signatures, watermarks, bandwidth, source identification (e.g., a uniform resource locator, etc.), quality information (e.g., media is a 1080p video, etc.) or tag information (e.g., a geotag, etc.) from the collected data. This process often requires substantial memory, data, and power (e.g., battery) to perform. In some cases, a user of the mobile device may experience unwanted effects due to these requirements (e.g., shorter battery life, loss of memory dedicated to desired user programs, high data usage, etc.)

In examples disclosed herein, the AME utilizes a meter that obtains media monitoring data (e.g., impression statistics, media consumption duration, etc.) for a mobile device (e.g., the meter may be implemented by software executing on the mobile device by a standalone meter, etc.). The meter may determine a first portion of the media monitoring data to be processed by the mobile device and a second portion to be processed by a local device such as an Internet of Things (IoT) device. The determination is based on resource information of the IoT device and the media monitoring data collected. The meter transfers the second portion of the media monitoring data to the IoT device for processing. The meter then processes the first portion and transmits the processed first portion to the collection server to be combined (e.g., by the collection server) with the processed second portion. By processing and transmitting the portion of the media monitoring data, the IoT device reduces the work done by the meter, resulting in longer battery life, increased memory and data storage, and a better user experience for a user of the mobile device.

As used herein, the term “local device” refers to a device or devices connected to a private network owned by an entity (e.g., an individual, a business, etc.). Additionally or alternatively, local devices may refer to devices located within a certain distance of one another (e.g., within a home, business, etc.). In some examples, a local device may be a device connected to a local network, wherein the local network is not a server. In examples disclosed herein, the mobile device and the IoT device may be communicatively coupled by a network. For example, the network may be a Bluetooth network, a Bluetooth Low Energy (BLE) network, a Wi-Fi Direct network, any other peer-to-peer (P2P) network, etc. In other examples, the network may be a client/server network (i.e., a network including a central server for data storage) in which data is distributed via an intermediary device (e.g., a modem, a router, etc.). A BLE network utilizes BLE communication protocols, which are implemented as wireless personal area network communication protocols that facilitate wireless communications between BLE-compatible devices (e.g., desktop computers, laptop computers, tablets, smartphones, and personal digital assistants (PDAs). Wi-Fi Direct is an example wireless technology standard enabling devices to connect to one another without the use of the wireless access point and a corresponding Internet connection. A Wi-Fi Direct connection allows users to display media, share information, and/or sync data without joining a traditional home, office, or hotspot network.

As used herein, the term “Internet of Things device” refers to a device connected to a network capable of receiving, processing, and/or transmitting data. For example, the IoT device may be a consumer electronics device, a manufacturing device, or any other device including a processing element and a network interface. Examples of IoT devices include smart TV's, smart outlets, tablets, pacemakers, thermostats, etc. In some disclosed examples, the meter may obtain resource information about the IoT devices such as available memory, processing power, data storage information, and/or any other information relevant to the performance of the IoT device. In some further examples, the resource information additionally or alternatively includes configuration information, such as a media access control (MAC) address, an internet protocol (IP) address, a service set identifier (SSID), a vendor identifier (VID), etc. In some cases, the configuration information is stored in the IoT device by a manufacturer before the IoT device is sold, used, etc.

In examples disclosed herein, the collection server combines the portions of processed data from the mobile device and the IoT device using a mapping tool. For example, the mapping tool may be a look-up table including device identifiers of the mobile device and the IoT device. The mapping tool may receive device identifiers associated with portions of processed data. For example, the collection server may receive instructions for the mapping tool included with one or more data portions. The instructions enable the mapping tool to use a look-up table to match the device to the received processed data portion (e.g., using the device identifiers). Using the device identifiers, the mapping tool may combine the portions of processed data into a configuration that corresponds to the structure of the data prior to determining the first and second portions of the media monitoring data (e.g., to reassemble the portions to be in a proper (e.g., chronological) order).

In examples disclosed herein, the resource information of the meter is stored by the local devices. For example, the meter may forget or lose resource information (e.g., a Wi-Fi username and/or password, login history, etc.) it is associated with (e.g., if connection to a router storing the information is lost, if power to the meter is lost, etc.). In response, the meter may transmit a request including a serial number associated with the meter via a network (e.g., a Bluetooth network) to the local devices for the resource information. The local devices include previously stored resource information associated with the serial number of the meter and may transmit a response with the resource information to the meter.

In examples disclosed herein, the determination of the first portion of the media monitoring data and the second portion of the media monitoring data are evaluated based on predetermined criteria. The first portion and the second portion are redetermined if the predetermined criteria are not met. For example, the first portion and the second portion may be allocated such that the time for processing of the second portion by the IoT device meets a threshold (e.g., too much data is to be processed by the IoT device). The first portion and the second portion may be redetermined to increase the amount of data included in the first portion and decrease the amount of data included in the second portion to decrease processing time.

Some examples disclosed herein include a single IoT device communicatively coupled to the mobile device (e.g., via a network). However, in some examples, multiple IoT devices may be available to the mobile device. In some such examples, the media monitoring data may be allocated among the multiple IoT devices. Additionally, some examples may include multiple metered devices, each of which may allocate media monitoring data to local devices (e.g., the IoT device(s), etc.) Further, in some examples, the metered device or devices may not be a mobile device (i.e., the metered device may be a desktop computer, a television, or any other device including a meter).

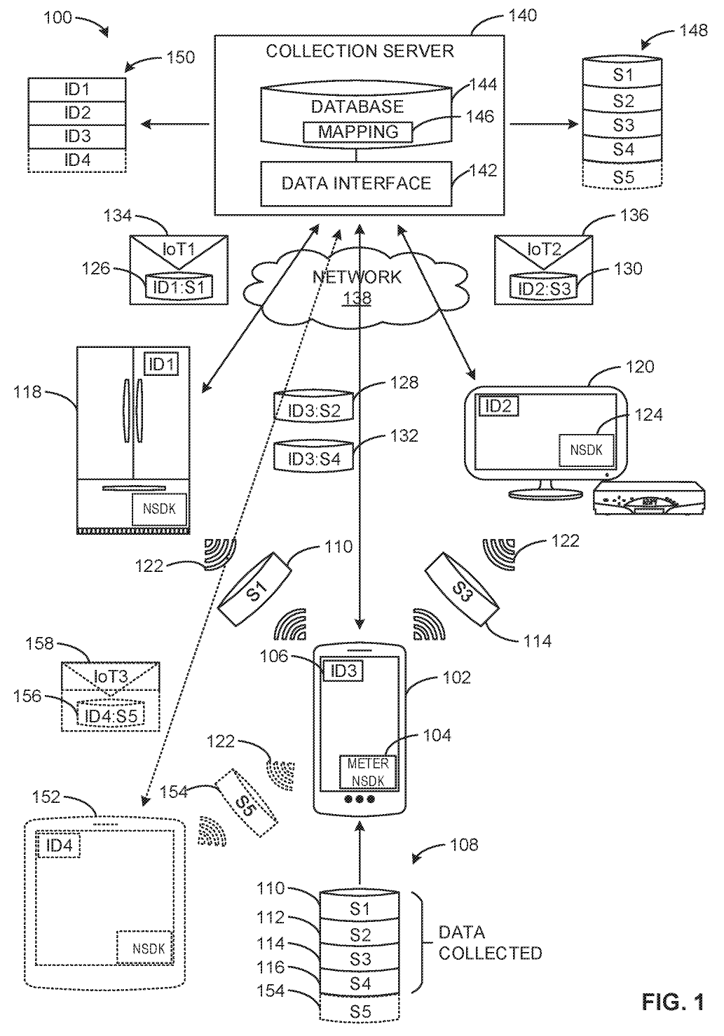

FIG. 1 is block diagram of an example environment 100 constructed in accordance with the teachings of this disclosure to improve data collection from mobile devices. The example environment 100 may include a mobile device 102 with a meter 104 executing on the mobile device 102. In the illustrated example, the mobile device 102 is a smartphone. In some other examples, the mobile device 102 may be any other device (e.g., a tablet, a television, a computer, etc.). In the illustrated example, the meter 104 is an application created via a software development kit (SDK). In some alternative examples, the meter 104 may be a standalone metering device. In some such examples, the application may be a background application that operates without requiring user inputs. In some other examples, the meter 104 may be implemented via a webserver or web browser extension. In the illustrated example, the mobile device 102 includes a device identifier (ID) 106. The device ID 106 of the illustrated example may be used to identify the mobile device 102. In some examples, the device ID 106 may be a string of numbers used to identify a device.

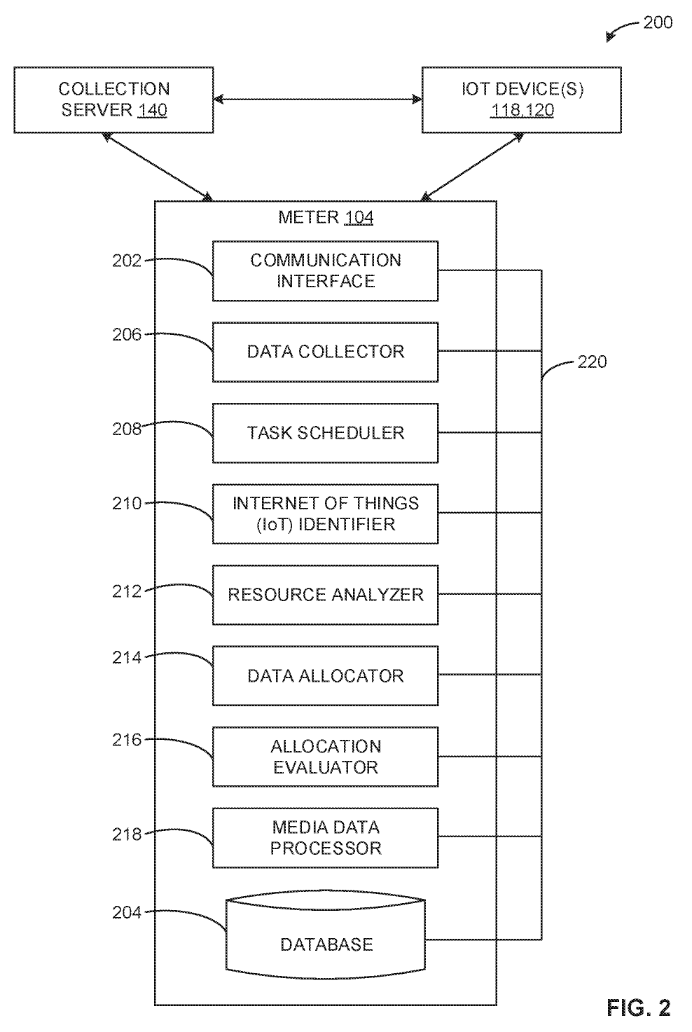

In the illustrated example, the meter 104 collects media monitoring data 108 associated with the mobile device 102. The media monitoring data 108 includes data corresponding to any type of content and/or advertisement delivered via any type of distribution medium accessed by the mobile device 102. For example, the meter 104 may collect media monitoring data 108 when the mobile device 102 is used to access advertisements, movies, web sites, streaming media, etc. In some examples, the media monitoring data 108 may be collected over a period of time. In the illustrated example, the media monitoring data 108 includes a first data portion 110, a second data portion 112, a third data portion 114, and a fourth data portion 116. In some examples, the data portions 110-116 may be divided based on types of media monitoring data 108. For example, each of the data portions 110-116 may include media monitoring data 108 from different sources (e.g., the first data portion 110 includes web site content, the second data portion 112 includes streaming media, etc.). In other examples, each of the data portions 110-116 may be from the same source (e.g., a single video separated into portions). For example, the data portions 110-116 may be data from mutually exclusive sections of a video (e.g., the data portions 110-116 do not include overlapping data). The media monitoring data 108 of the illustrated example is divided according to criteria determined by the meter 104, which is described in more detail below in connection with FIG. 2.

In the illustrated example, the data portions 110-116 are distributed to the mobile device 102, a first Internet of Things (IoT) device 118, and a second IoT device 120. In the illustrated example, the first data portion 110 is distributed to the first IoT device 118. In the illustrated example, the first data portion 110 is distributed via a Bluetooth network 122. In some examples, the first data portion 110 may be distributed via a Bluetooth Low Energy (BLE) network, a Wi-Fi Direct network, or any other peer-to-peer (P2P) network. In some other examples, the first data portion 110 may be indirectly communicatively coupled and therefore distributed via an intermediary device (e.g., a modem, a router, etc.).

In the illustrated example, the first IoT device 118 is a smart refrigerator (i.e., a refrigerator with internet capabilities). In other examples, the first IoT device 118 may be any other internet-capable device (e.g., a smart outlet, tablet, etc.). The first IoT device 118 includes an IoT SDK 124. The IoT SDK 124 allows the first IoT device to receive and/or process data, communicate information to the mobile device 102 or other devices, and/or perform other tasks through the Bluetooth network 122, the Internet, or any other medium. The first IoT device 118 of the illustrated example is to process the first data portion 110 received from the meter 104 using the IoT SDK 124. In the illustrated example, the IoT SDK 124 of the first IoT device 118 combines the device ID 106 with the first data portion 110.

In some examples, the IoT SDK 124 may be distributed to the first IoT device 118 via an upgrade, an update, etc. In some examples, the IoT SDK 124 is installed by a manufacturer before the first IoT device 118 is implemented in the example environment 100. In such examples, the manufacturer may be incentivized to preinstall the IoT SDK 124 on an IoT device (e.g., a smart refrigerator, smart outlet, smart TV, etc.). For example, the manufacturer may be provided with metering data reports at low or no cost or may receive utilization information regarding one or more devices with the IoT SDK 124 installed. By preinstalling the IoT SDK 124, the IoT device (e.g., the first IoT device 118, the second IoT device 120, etc.) may communicate with the meter 104 or any other meter compatible with (e.g., may accept messages from and send responses to) the IoT SDK 124.

In the illustrated example, the third data portion 114 is distributed to the second IoT device 120 via the Bluetooth network 122. The second IoT device 120 of the illustrated example is a smart TV. However, in some other examples, the second IoT device 120 may be any other internet-capable device (e.g., a smart outlet, tablet, etc.). The second IoT device 120 includes another IoT SDK 124 to receive and/or process data, communicate with the mobile device 102 or other devices, and/or perform other tasks through the Bluetooth network, the Internet, or any other medium. In the illustrated example, the second IoT device 120 receives and processes the third data portion 114. In the illustrated example, the IoT SDK 124 of the second IoT device 120 combines the device ID 106 with the third data portion 114.

In the illustrated example, the meter 104 processes the second data portion 112 and the fourth data portion 116. The meter 104 of the illustrated example combines each of the second and fourth data portions 112 and 116 with the device ID 106. In the illustrated example, a first processed data portion 126, a second processed data portion 128, a third processed data portion 130, and a fourth processed data portion 132 are transmitted from their respective devices.

In the illustrated example, the first processed data portion 126 is transmitted from the first IoT device 118 within a first data message 134. In some examples, the first data message 134 may be an Internet message (e.g., a HyperText Transfer Protocol (HTTP) request(s)). Additionally or alternatively, any other method(s) to receive and/or transmit the media monitoring data 108 may be used, such as, for example, an HTTP Secure protocol (HTTPS), a file transfer protocol (FTP), a secure file transfer protocol (SFTP), etc. The first data message 134 includes the device ID 106 in addition to the first processed data portion 126. In the illustrated example, the third processed data portion 130 is transmitted from the second IoT device 120 within a second data message 136. The second data message 136 of the illustrated example includes the third processed data portion 130 and the device ID 106. In some examples, the second data message 136 may be an Internet message. Additionally or alternatively, any other method(s) to receive and/or transmit the media monitoring data 108 may be used such as, for example, an HTTP Secure protocol (HTTPS), a file transfer protocol (FTP), a secure file transfer protocol (SFTP), etc. The meter 104 of the illustrated example transmits the second processed data portion 128 and the fourth processed data portion 132. In the illustrated example, the second processed data portion 128 and the fourth processed data portion 132 include the device ID 106. In some examples, the second processed data portion 128 and the fourth processed data portion 132 may be transmitted within an Internet message.

In the illustrated example, the processed data portions 126-132 are transmitted with the device ID 106 for each device via a network 138 to a collection server 140. The network 138 of the illustrated example of FIG. 1 is the Internet. However, the example network 138 may be implemented using any suitable wired and/or wireless network(s) including, for example, one or more data buses, one or more Local Area Networks (LANs), one or more wireless LANs, one or more cellular networks, one or more private networks, one or more public networks, etc. The example network 138 enables the example mobile device 102, the example first IoT device 118, and the example second IoT device 120 to be in communication with the example collection server 140.

In the illustrated example, the collection server 140 includes a data interface 142 and a database 144. The database 144 of the collection server 140 further includes a mapping tool 146. In the illustrated example, the data interface 142 is communicatively coupled with the mobile device 102, the first IoT device 118, and the second IoT device 120 (i.e., via the network). The collection server 140 of the illustrated example receives the processed data portions 126-132 via the data interface 142 and stores the processed data portions 126-132 in the database 144. In the illustrated example, the mapping tool 146 accesses the processed data portions 126-132 stored in the database 144 and recompiles the processed data portions 126-132 into processed media monitoring data 148. The processed media monitoring data 148 of the illustrated example has an identical configuration to the media monitoring data 108. In some other examples, the configuration of the processed media monitoring data 148 is not identical to the configuration of the media monitoring data 108. The mapping tool 146 of the illustrated example matches each of the processed data portions 126-132 with a respective device ID 106 using a map 150. In some examples, the map 150 is a look-up table transmitted to the collection server 140 from the mobile device 102. In some examples, the map 150 is transmitted with the second and fourth processed data portions 128 and 132 within an Internet message. In some other examples, the mobile device 102 may transmit the map 150 to the collection server 140 prior to distributing the data portions 110-116.

In the preceding illustrated example, the example environment 100 included two IoT devices, the first IoT device 118 and the second IoT device 120. In some alternative examples, the environment may additionally include a third IoT device 152. Such an example is illustrated within the example environment 100 of FIG. 1.

In the illustrated example, an example fifth data portion 154 is collected by the meter 104. In some examples, the fifth data portion 154 is a different type of media monitoring data than the data portions 110-116 (i.e., collected from a different source). In some other examples, the fifth data portion 154 is the same type of media monitoring data as one or more of the data portions 110-116 (e.g., a portion of the same video as one or more of the data portions 110-116). The fifth data portion 154 of the illustrated example is distributed by the meter 104 to the third IoT device 152. In the illustrated example, the fifth data portion 154 is distributed via the Bluetooth network 122. In other examples, the fifth data portion 154 may be distributed by any other network (e.g., the Internet).

In the illustrated example, the third IoT device 152 is a tablet. However, in some other examples, the third IoT device 152 may be any other internet-capable device (e.g., a smart outlet, etc.). The third IoT device 152 of the illustrated example includes another IoT SDK 124 to receive and process data, communicate with the mobile device or other devices, and/or perform other tasks through the Bluetooth network, internet, or any other medium. In the illustrated example, the third IoT device 152 receives and processes the fifth data portion 154 The IoT SDK 124 of the illustrated example of the third IoT device 152 combines the device ID 106 with the fifth portion of data 154.

In the illustrated example, a fifth processed data portion 156 is transmitted to the collection server 140 within a third data message 158. The data interface 142 of the illustrated example receives the fifth processed data portion 156 and stores it within the database 144. The data interface 142 of the illustrated example is additionally communicatively coupled with the third IoT device 152. In the illustrated example, the mapping tool 146 recompiles the fifth processed data portion 156 along with the processed data portions 126-132 into the processed media monitoring data 148 using the map 150.

FIG. 2 is a block diagram of an example implementation of the meter 104 of FIG. 1 to implement the examples disclosed herein. In the illustrated example, the meter 104 includes a communication interface 202, a database 204, a data collector 206, a task scheduler 208, an Internet of Things (IoT) Identifier 210, a resource analyzer 212, a data allocator 214, an allocation evaluator 216, a media data processor 218, and a bus 220. In some other examples, the meter 104 may include other components for collecting, processing, distributing, transmitting, and/or storing data.

The example meter 104 includes means for transmitting. In the illustrated example, the means for transmitting is implemented by the example communication interface 202 that communicatively couples the meter 104 to one or more IoT devices, such as the first and second IoT devices 118 and 120 of FIG. 1, and the example collection server 140 of FIG. 1. The communication interface 202 of the illustrated example transmits and/or receives Internet messages that include media monitoring data, such as the example media monitoring data 108 of FIG. 1. Additionally or alternatively, any other method(s) to receive and/or transmit the media monitoring data 108 may be used such as, for example, an HTTP Secure protocol (HTTPS), a file transfer protocol (FTP), a secure file transfer protocol (SFTP), etc. The communication interface 202 of the illustrated example also receives and/or transmits resource information relevant to the IoT device 118,120. In some examples, the resource information includes data storage information and/or memory usage information of the IoT device 118,120. In some further examples, the resource information may additionally or alternatively include configuration information such as a media access control (MAC) address, internet protocol (IP) address, and/or other device-identifying information (e.g., a service set identifier (S SID), a vendor identifier (VID), etc.).

In the illustrated example, the information received via the internet messages (e.g., the media monitoring data 108, resource information, etc.) at the communication interface 202 is stored in the database 204. The database 204 of the illustrated example is included in the meter 104. In alternative examples, the database 204 may be an external database in communication with the meter 104.

In the illustrated example, the data collector 206 obtains the media monitoring data 108 from a mobile device, such as the mobile device 102 of FIG. 1. The data collector 206 of the illustrated example may obtain detailed media consumption behavior of a mobile device user such as, for example, a media genre type, web content accessed by the user, application use, streaming content, etc. The data collector 206 of the illustrated example may transmit the media monitoring data 108 to the database 204 via the bus 220 to be stored. In the illustrated example, the bus 220 communicatively couples each of the components of the meter 104 (e.g., the communication interface 202, the database 204, the data collector 206, etc.).

In the illustrated example, the task scheduler 208 determines when the meter 104 is to transmit the media monitoring data 108 to the IoT device 118,120 and/or the collection server 140. In some examples, the task scheduler 208 may determine that the meter 104 is to transmit the media monitoring data 108 based on an amount of the media monitoring data 108 collected and stored in the database 204. In some such examples, the task scheduler 208 may determine that the media monitoring data 108 must be transmitted because the storage space of the database 204 has fallen below a threshold. In some examples, the task scheduler 208 may make the determination based on an amount of time between a previous transmission of the media monitoring data 108. The task scheduler 208 of the illustrated example may also determine that the meter 104 is to transmit a request for resource information to the IoT device 118,120. In some examples, the request for resource information is transmitted when the resource information of the IoT device 118,120 is unknown or lost. In some alternative examples, the request is transmitted when one or more new IoT device(s), such as the third IoT device 152 of FIG. 1, have been placed in communication with the mobile device 102.

The example meter 104 also includes means for identifying. In the illustrated example, the means for identifying is implemented by the example IoT identifier 210 that identifies the IoT device 118,120 in communication with the meter 104. The IoT identifier 210 of the illustrated example may query a network, such as the Bluetooth network 122 of FIG. 1, for the IoT device 118,120. In some examples, the IoT identifier 210 constantly queries the example Bluetooth network 122 for IoT devices. In some other examples, the IoT identifier 210 may query the example Bluetooth network 122 periodically based on input from the task scheduler 208. When the IoT identifier 210 of the illustrated example identifies the IoT device 118,120, the communication interface 202 may transmit an Internet message with a request for resource information to the IoT device 118,120.

The example meter 104 also includes means for obtaining. In the illustrated example, the means for obtaining is implemented by the example resource analyzer 212 that receives transmitted resource information from the IoT device 118,120. The resource analyzer 212 of the illustrated example analyzes the resource information of the IoT device 118,120 and determines device characteristics for the IoT device 118,120. In some examples, the device characteristics include data storage space, memory usage, and/or data usage characteristics. In some further examples, the device characteristics may include processor characteristics (e.g., clock speed, bus speed, etc.). In the illustrated example, the resource analyzer 212 outputs the device characteristics of each of the IoT device 118,120 to the data allocator 214.

The resource analyzer 212 of the illustrated example additionally collects resource information of the meter 104. The resource information of the meter 104 may include a serial number for the meter 104, Wi-Fi settings (e.g., a username and/or a password), additional network information, collected metering data, and/or additional meter information (e.g., login history, local device resource information, etc.). In some examples, some or all of the resource information of the example meter 104 may be unknown and/or forgotten. For example, the meter 104 may forget the resource information it is associated with due to a memory corruption or failure, a loss in network connection (e.g., the meter loses connection to a router), a loss of power (i.e., the mobile device 102 runs out of battery), etc. Additionally or alternatively, the meter 104 may be replaced with a new, unprovisioned meter. The meter 104 may therefore transmit a request for resource information to local devices (e.g., the one or more IoT device such as the third IoT device 152 of FIG. 1, etc.) via a network, such as the Bluetooth network 122 of FIG. 1. In some examples, the communication interface 202 inserts the serial number (or other identification information) of the meter 104 in the request for resource information. The local devices may have the resource information for the meter 104 stored in a database and may transmit the resource information to the meter 104. The meter 104 may then store the resource information received in the response(s) from other network device(s). In some other examples, the meter 104 may not include a serial number in the request for resource information.

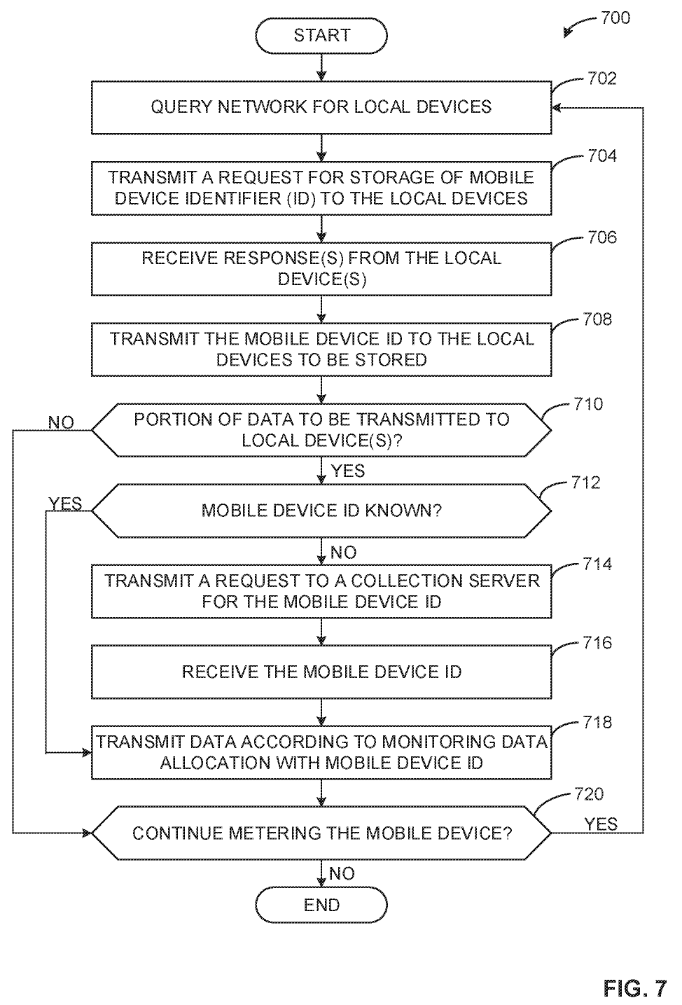

In some examples, the meter 104 may forget or lose the example device ID 106 of FIG. 1 (a panelist identifier, an identification marker, etc.) associated with the mobile device 102 (e.g., the device ID 106 may be erased by privacy protection agents, user actions, other malicious agents, etc.). In such examples, the communication interface 202 may transmit a request to the example collection server 140 of FIG. 1 for the device ID 106 associated with the mobile device 102. The example collection server 140 may recover the device ID 106 associated with the mobile device 102 by analyzing the processed data portions (e.g., the example processed data portions 126-132) to extract the device ID 106 (or chain of device IDs) from the processed data portions. For example, the data collection server 140 may apply a heuristic algorithm to identifiers included in the processed data portions to identify a device identifier that is most likely to be associated with the meter 104 and/or the mobile device 102 (e.g., to distinguish the device identifier of the meter 104 from device identifiers associated with IoT device 152). An example process for retrieving the device ID 106 is described in further detail in conjunction with FIGS. 7, 8, and 10.

In some examples, the communication interface 202 may receive more than one response from the local devices and may the resource analyzer 212 may analyze the received resource information. In such examples, the resource analyzer 212 may select the resource information found in a majority of the responses from the local devices (e.g., a consensus of the responses). In other examples, the resource analyzer 212 may receive only one response (e.g., a response from only the third IoT device 152). In such an example, the resource analyzer 212 determines the resource information from the one response.

The example meter 104 also includes means for assigning. In the illustrated example, the means for assigning is implemented by the example data allocator 214 that receives the device characteristics and determines a monitoring data allocation. In the illustrated example, the monitoring data allocation is determined based on the media monitoring data 108 collected by the data collector 206 and the device characteristics output by the resource analyzer 212. The monitoring data allocation assigns portions of the media monitoring data 108, such as the example data portions 110-116 of FIG. 1, to the IoT device 118,120 and/or the mobile device 102. In some examples, the data allocator 214 assigns each of the example data portions 110-116 to the IoT device 118,120 (i.e., the data allocator 214 does not assign any of the example data portions 110-116 to the mobile device 102). In some alternative examples, the data allocator 214 may assign one or more of the example data portions 110-116 to the IoT device 118,120 and one or more of the example data portions 110-116 to the mobile device 102.

In some examples, the data allocator 214 calculates the monitoring data allocation based on the processor characteristics of the IoT device 118,120 and/or the mobile device 102. In such examples, the data allocator 214 may maximize the amount of the media monitoring data 108 to be processed by assigning the example data portions 110-116 based on the processor characteristics. For example, if the resource analyzer 212 determines that the IoT device 118,120 has processor characteristics indicative of low processing power, the data allocator 214 may assign a larger portion of the media monitoring data 108 to the mobile device 102. In another such example, two IoT devices may be communicatively coupled to the mobile device 102. In such an example, the resource analyzer 212 may determine that one IoT device 118,120 (e.g., the first IoT device 118 of FIG. 1) has more processing power than another IoT device (e.g., the second IoT device 120 of FIG. 1). The data allocator 214 may then assign a larger portion of data to the first IoT device 118 in order to process more total media monitoring data.

The example meter 104 also includes means for evaluating. In the illustrated example, the means for evaluating is implemented by the example allocation evaluator 216 that evaluates the monitoring data allocation calculated by the data allocator 214 based on predetermined criteria. In some examples, the predetermined criteria of the allocation evaluator include a processing time threshold. In such examples, when the processing time threshold for processing the media monitoring data (e.g., a total processing time for the example data portions 110-116 at the IoT device 118,120 and/or the mobile device 102) meets the processing time threshold, the allocation evaluator 216 may alert the data allocator 214. In such an example, the data allocator 214 may redetermine the monitoring data allocation based on the alert from the allocation evaluator 216. In some alternative examples, the allocation evaluator 216 may include alternative or additional criteria (e.g., a memory usage threshold, a data usage threshold, etc.).

The example meter 104 also includes means for processing. In the illustrated example, the means for processing is implemented by the example media data processor 218 that processes the media monitoring data 108 distributed to the mobile device 102 by the data allocator 214. The media data processor 218 of the illustrated example may access the media monitoring data 108 stored in the database 204 and process the data portion(s) (e.g., one or more of the example data portions 110-116) assigned to the mobile device 102. For example, the media data processor 218 may extract embedded codes, signatures, watermarks, etc. from the media monitoring data 108. In another example, the media data processor 218 may extract information relating to bandwidth, source identification (e.g., a uniform resource locator, etc.), quality information (e.g., media is a 1080p video, etc.) or tag information (e.g., a geotag, etc.) from the media monitoring data 108. In some alternative examples, the data allocator 214 may not assign any data portion(s) to the mobile device 102. In such alternative examples, the media data processor 218 does not process any of the media monitoring data 108.

In the illustrated example, the communication interface 202 transmits the data processed by the media data processor 218 to the collection server 140 (e.g., within an Internet message). In some examples, the communication interface 202 transmits a device identifier (ID), such as the device ID 106 of FIG. 1, with the processed media monitoring data (e.g., the example second processed data portion 128 of FIG. 1). At the collection server 140, the processed media monitoring data transmitted from the mobile device 102 may be combined with processed data from the IoT device 118,120. In some examples, the collection server includes the example data interface 142, the example database 144, and the example mapping tool 146 of FIG. 1. In such examples, the processed media monitoring data from the mobile device and/or the IoT device 118,120 is combined in accordance with the methods disclosed in FIG. 1.

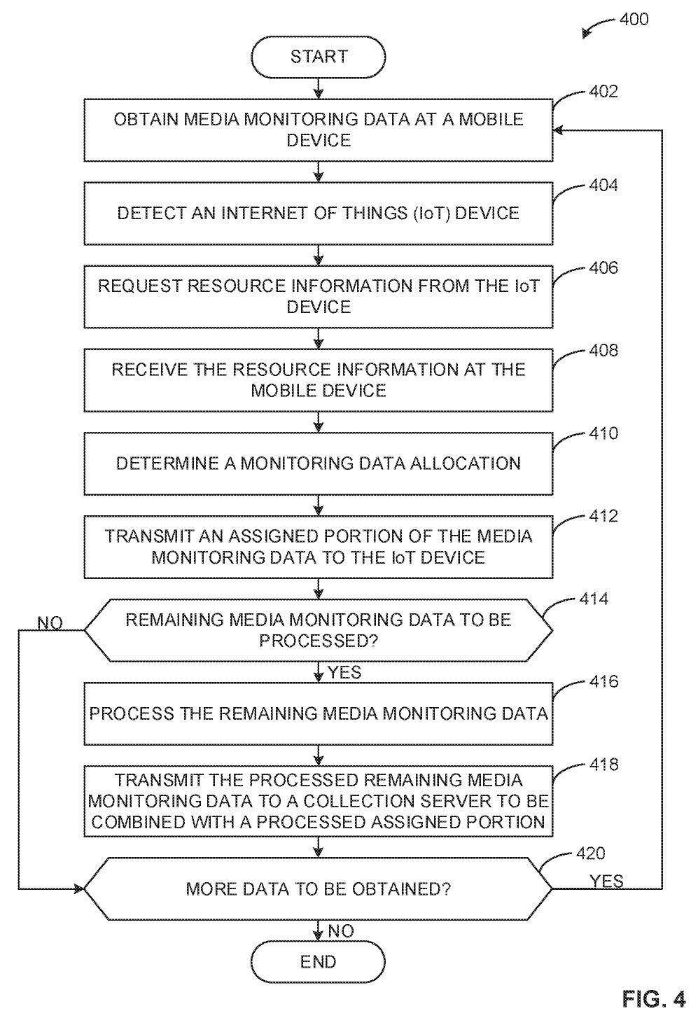

While an example manner of implementing the meter 104 of FIG. 1 is illustrated in FIG. 2, one or more of the elements, processes and/or devices illustrated in FIG. 2 may be combined, divided, re-arranged, omitted, eliminated and/or implemented in any other way. Further, the example communication interface 202, the example data collector 206, the example task scheduler 208, the example IoT identifier 210, the example resource analyzer 212, the example data allocator 214, the example allocation evaluator 216, the example media data processor 218, and/or, more generally, the example meter 104 of FIG. 2 may be implemented by hardware, software, firmware and/or any combination of hardware, software and/or firmware. Thus, for example, any of the example communication interface 202, the example data collector 206, the example task scheduler 208, the example IoT identifier 210, the example resource analyzer 212, the example data allocator 214, the example allocation evaluator 216, the example media data processor 218, and/or, more generally, the example meter 104 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example communication interface 202, the example data collector 206, the example task scheduler 208, the example IoT identifier 210, the example resource analyzer 212, the example data allocator 214, the example allocation evaluator 216, and/or the example media data processor 218 is/are hereby expressly defined to include a non-transitory computer readable storage device or storage disk such as a memory, a digital versatile disk (DVD), a compact disk (CD), a Blu-ray disk, etc. including the software and/or firmware. Further still, the example meter 104 of FIG. 1 may include one or more elements, processes and/or devices in addition to, or instead of, those illustrated in FIG. 4, and/or may include more than one of any or all of the illustrated elements, processes and devices.

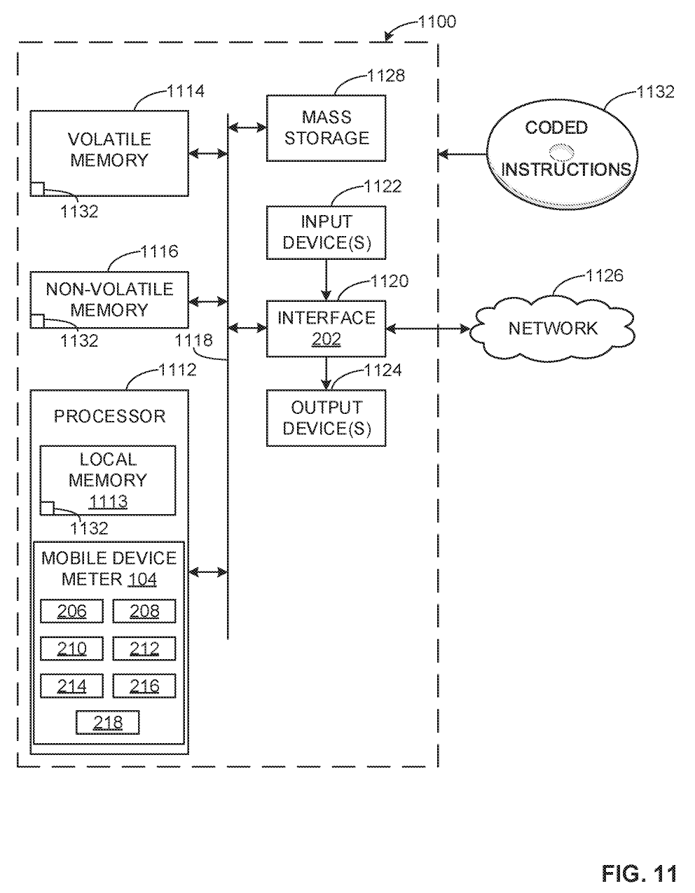

Flowcharts representative of example machine readable instructions for implementing the meter 104 of FIGS. 1-2 are shown in FIGS. 4 and 7. In these example, the machine readable instructions comprise a program for execution by a processor such as a processor 1112 shown in the example processor platform 1100 discussed below in connection with FIG. 11. The program may be embodied in software stored on a non-transitory computer readable storage medium such as a CD-ROM, a floppy disk, a hard drive, a DVD, a Blu-ray disk, or a memory associated with the processor 1112, but the entire program and/or parts thereof could alternatively be executed by a device other than the processor 1112 and/or embodied in firmware or dedicated hardware. Further, although the example program is described with reference to the flowcharts illustrated in FIGS. 4 and 7, many other methods of implementing the example meter 104 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

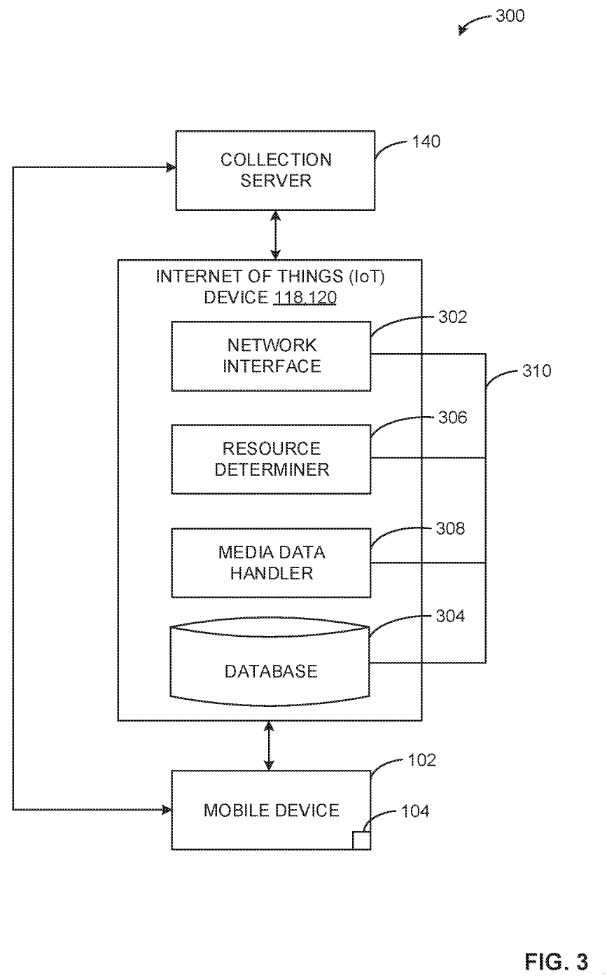

FIG. 3 is a block diagram of an example implementation of the Internet of Things (IoT) device of FIG. 1 to implement the examples disclosed herein. In the illustrated example, the IoT device 118,120 includes a network interface 302, a database 304, a resource determiner 306, and a media data handler 308. In the illustrated example, the components of the IoT device 118,120 are communicatively coupled via a bus 310. The IoT device 118,120 may receive and process media monitoring data, such as the media monitoring data 108 of FIG. 1, from a mobile device, such as the mobile device 102 of FIG. 1. The media monitoring data processed by the IoT device 118,120 may then be transmitted to a collection server, such as the collection server 140 of FIG. 1. By offloading data from the mobile device 102 to the IoT device 118,120 for processing, the mobile device 102 may preserve battery life, data usage, and available memory.

In the illustrated example, the network interface 302 communicatively couples the IoT device 118,120 to the example mobile device 102 of FIG. 1 and the example collection server 140 of FIGS. 1-2. In some examples, the network interface 302 communicatively couples the IoT device 118,120 to the mobile device 102 and the collection server 140 via a Bluetooth network such as the example Bluetooth network 122 of FIG. 1. In some other examples, the network interface 302 may utilize a network such as the network 138 of FIG. 1 or any peer-to-peer network (e.g., a Bluetooth Low Energy (BLE) network, a Wi-Fi Direct network, etc.). In some examples, the network interface 302 transmits and receives internet messages. In such examples, the internet messages may include media monitoring data, data handling instructions, and/or other information to be utilized in the receiving, processing, and/or transmitting of data.

In the illustrated example, the resource determiner 306 determines resource information associated with the IoT device 118,120. In some examples, the resource information includes data usage information, memory usage information, and/or processor characteristics (e.g., clock speed, bus speed, etc.). Additionally or alternatively, the resource information may include configuration information such as a media access control (MAC) address, an internet protocol (IP) address, a service set identifier (SSID), a vendor identifier (VID), etc. In the illustrated example, the resource determiner 306 stores the resource information in the database 304. The database 304 of the illustrated example is included in the IoT device 118,120. In alternative examples, the database 304 may be an external database in communication with the IoT device 118,120. In some examples, the resource determiner 306 includes predetermined resource information (e.g., installed by a manufacturer).

The resource determiner 306 of the illustrated example may additionally store the resource information of other network devices (e.g., the mobile device 102, etc.). In some examples, the resource information of other network devices is stored in the database 304. In some examples, the resource determiner 306 stores the resource information of all known network devices in a table. In some examples, each network device includes the resource information of every device included in the network.

In the illustrated example, the network interface 302 transmits the resource information determined by the resource determiner 306 to the meter 104. In the illustrated example, the meter 104, in response to receiving the resource information, assigns and transmits a portion of the media monitoring data (e.g., one or more of the data portions 110-116 of FIG. 1) to the IoT device 118,120. In some examples, the assigned data portion(s) may be stored in the database 304.

In the illustrated example, the media data handler 308 accesses the data portion(s) from the database 304. The media data handler 308 of the illustrated example processes the portion of the media monitoring data 108. In some examples, the media data handler 308 may receive processing instructions from the meter 104. For example, the meter 104 may instruct the media data handler 308 to extract information related to embedded codes, signatures, watermarks, bandwidth, source identification (e.g., a uniform resource locator, etc.), quality information (e.g., media is a 1080p video, etc.) or tag information (e.g., a geotag, etc.) from the assigned data portion(s). In the illustrated example, the IoT device 118,120 transmits the processed assigned data portion(s) of the media monitoring data 108 to the collection server 140 to be combined with other processed media monitoring data.

While an example manner of implementing the IoT device 118,120 of FIGS. 1-2 is illustrated in FIG. 3, one or more of the elements, processes and/or devices illustrated in FIG. 3 may be combined, divided, re-arranged, omitted, eliminated and/or implemented in any other way. Further, the example network interface 302, the example resource determiner 306, the example media data handler 308, and/or, more generally, the example IoT device 118,120 of FIG. 3 may be implemented by hardware, software, firmware and/or any combination of hardware, software and/or firmware. Thus, for example, any of the example network interface 302, the example resource determiner 306, the example media data handler 308, and/or, more generally, the example IoT device 118,120 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example network interface 302, the example resource determiner 306, the example media data handler 308 is/are hereby expressly defined to include a non-transitory computer readable storage device or storage disk such as a memory, a digital versatile disk (DVD), a compact disk (CD), a Blu-ray disk, etc. including the software and/or firmware. Further still, the example IoT device 118,120 of FIGS. 1-2 may include one or more elements, processes and/or devices in addition to, or instead of, those illustrated in FIG. 3, and/or may include more than one of any or all of the illustrated elements, processes and devices.

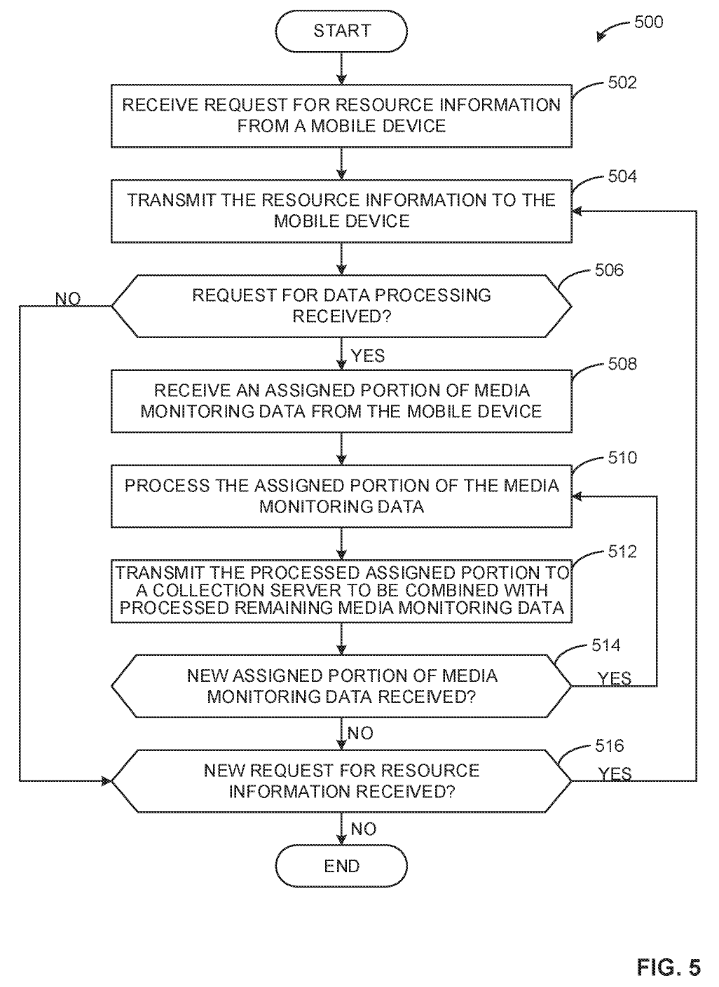

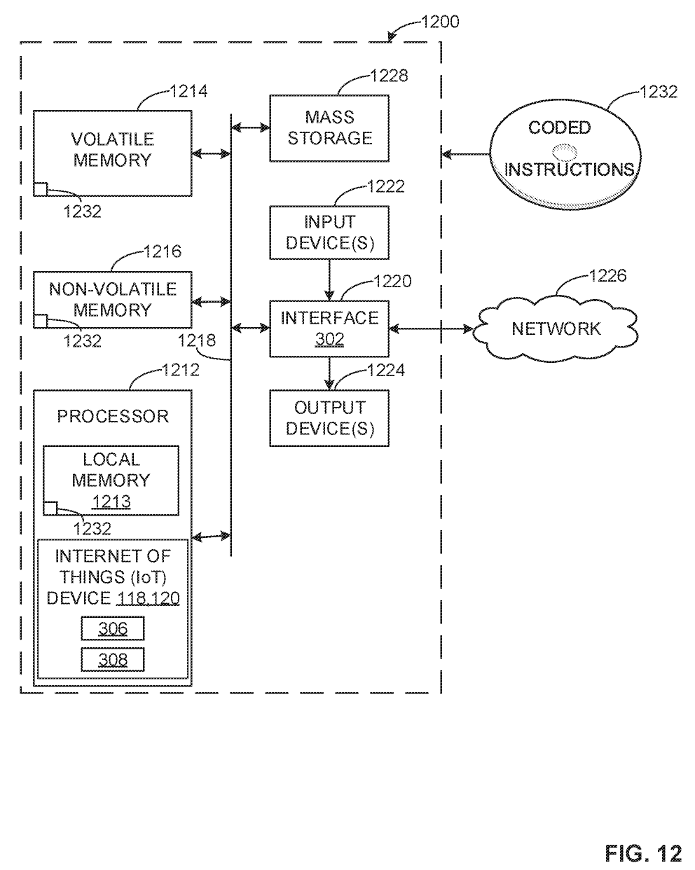

Flowcharts representative of example machine readable instructions for implementing the IoT device 118,120 of FIG. 3 are shown in FIGS. 5-6 and 8. In these examples, the machine readable instructions comprise programs for execution by a processor such as a processor 1212 shown in the example processor platform 1200 discussed below in connection with FIG. 12. The programs may be embodied in software stored on a non-transitory computer readable storage medium such as a CD-ROM, a floppy disk, a hard drive, a DVD, a Blu-ray disk, or a memory associated with the processor 1212, but the entire programs and/or parts thereof could alternatively be executed by a device other than the processor 1212 and/or embodied in firmware or dedicated hardware. Further, although the example programs are described with reference to the flowcharts illustrated in FIGS. 5-6 and 8, many other methods of implementing the example IoT device 118,120 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operations without executing software or firmware.

FIG. 4 is a flow diagram of example machine readable instructions which may be executed to implement the example meter 104 to collect, process, and transmit media monitoring data. The example program 400 of FIG. 4 begins at block 402 when the example meter 104 obtains media monitoring data at the example mobile device 102. For example, the example data collector 206 of FIG. 2 may collect media monitoring data, such as the example media monitoring data 108 of FIG. 1, indicative of media consumed by a user (e.g., streaming media, web content, etc.) of the example mobile device 102. In such an example, the data collector 206 may store the media monitoring data in a database, such as the example database 204 of FIG. 2.

At block 404, the example meter 104 detects an Internet of Things (IoT) device, such as the example IoT device 118,120 of FIGS. 1-3 (block 404). For example, the example Internet of Things Identifier 210 of FIG. 2 may identify the IoT device 118,120 in communication with the meter 104 (e.g., via a network such as the Bluetooth network 122 of FIG. 1). In some such examples, the IoT identifier 210 may constantly query the example Bluetooth network 122 for the IoT device 118,120.

At block 406, the example meter 104 requests resource information from the IoT device. For example, the example communication interface 202 of FIG. 2 may transmit an Internet message from the mobile device 102 to the IoT device 118,120 to request the resource information. The resource information may include memory usage information, data storage information, and/or processor information. Further, the resource information may include configuration information (e.g., a media access control (MAC) address, an internet protocol (IP) address, etc.)

At block 408, the example meter 104 receives the resource information at the mobile device 102. For example, the example resource analyzer 212 of FIG. 2 receives resource information transmitted from the IoT device 118,120. In some such examples, the resource analyzer 212 analyzes the resource information of the IoT device and determines characteristics of the IoT device 118,120.

At block 410, the example meter 104 determines a monitoring data allocation. For example, the example data allocator 214 of FIG. 2 receives the resource information from the example resource analyzer 212 and calculates a monitoring data allocation based on the example media monitoring data 108 and the resource information. In some such examples, the monitoring data allocation assigns portions of the media monitoring data, such as the example data portions 110-116 of FIG. 1, to the IoT device 118,120 and/or the meter 104. In another example, the example data allocator 214 may calculate the monitoring data allocation based additionally on processor characteristics of the IoT device 118,120 and/or the meter 104. In some such examples, the example data allocator 214 may maximize the amount of the media monitoring data 108 to be processed.

In further examples, the example allocation evaluator 216 of FIG. 2 may evaluate the monitoring data allocation calculated by the data allocator 214 based on predetermined criteria. For example, the predetermined criteria of the allocation evaluator may include a processing time threshold. When the processing time threshold for processing the media monitoring data (e.g., a total processing time for the example data portions 110-116 at the IoT device 118,120 and/or the mobile device 102) is exceeded, the allocation evaluator 216 may alert the data allocator 214, prompting the data allocator 214 to redetermine the monitoring data allocation based on the alert.

At block 412, the example meter 104 transmits an assigned portion of the media monitoring data (e.g., one or more of the example data portions 110-116) to the example IoT device 118,120. For example, the example communication interface 202 may transmit the assigned portion of the media monitoring data 108 to the IoT device 118,120 (e.g., within an Internet message). In some such examples, the example communication interface 202 may include processing instructions within the Internet message for the IoT device 118,120 to properly process the assigned portion and/or to properly transmit the processed assigned portion to a collection server, such as the collection server 140 of FIGS. 1-3.

At block 414, the example meter 104 determines whether there is remaining media monitoring data to be processed. For example, the example data allocator 214 may determine that there is media monitoring data remaining at the mobile device 102 (i.e., not all the media monitoring data 108 has been distributed to the example IoT device 118,120). In such examples, the example media data processor 218 accesses the remaining media monitoring data (e.g., from the example database 204) and control proceeds to block 416. In alternative examples, the example data allocator 214 may determine that there is no media monitoring data remaining at the mobile device 102 (i.e., all the media monitoring data 108 has been distributed to the example IoT device 118,120). In such examples, control proceeds to block 420 to determine whether more data is to be collected.

At block 416, the example meter 104 processes the remaining media monitoring data. For example, the example media data processor 218 may process the portion of data (e.g., one or more of the example data portions 110-116 of FIG. 1) assigned to the mobile device 102 by the data allocator 214. In some such examples, the example media data processor 218 may access the data portion(s) (e.g., one or more of the processed data portions 126-132 of FIG. 1) stored in the example database 204, process the data portion(s), and store the processed data portion(s) in the example database 204.

At block 418, the example meter 104 transmits the processed remaining media monitoring data to a collection server to be combined with a processed assigned portion. For example, the communication interface 202 may transmit the processed remaining media monitoring data from the example database 204 to the example collection server 140 within an Internet message. In some such examples, the internet message transmitted by the communication interface 202 further includes a map, such as the example map 150 of FIG. 1, of the monitoring data allocation. In such examples, the map further includes instructions for combining the processed data portions (e.g., one or more of the example processed data portions 126-132 of FIG. 1) at the example collection server 140 according to the monitoring data allocation.

At block 420, the example meter 104 determines whether more data is to be collected. For example, the example data collector 206 may determine that more data is being accessed on the example mobile device 102. In such an example, control returns to block 402, and more media monitoring data would be obtained by the data collector 206. In alternative examples, the data collector 206 may determine that no additional media monitoring data is being accessed by the mobile device 102 and/or no additional media monitoring data is to be collected. In such examples, the process concludes until such time as the example data collector 206 determines additional media monitoring data is to be collected.

FIG. 5 is a flow diagram of example machine readable instructions which may be executed to implement the example Internet of Things (IoT) device 118,120 to receive, process, and transmit media monitoring data assigned by the meter 104 of FIGS. 1-3. The example program 500 begins at block 502 when the IoT device 118,120 receives a request for resource information from a mobile device. For example, the IoT device 118,120 may receive a request from the example mobile device 102 at the example network interface 302 of FIG. 3. In such examples, the example resource determiner 306, in response to the request, determines the resource information according to the methods and techniques disclosed in connection with FIG. 3. In some such examples, the example resource determiner 306 stores the resource information in the example database 304 of FIG. 3.

At block 504, the example IoT device 118,120 transmits the resource information to the mobile device 102. For example, the example network interface 302 of the IoT device 118,120 may transmit the resource information stored in the example database 304 to the example mobile device 102.

At block 506, the example IoT device 118,120 determines whether a request for data processing has been received. For example, the example network interface 302 may receive a request for data processing from the example meter 104. In some such examples, the request may be an Internet message (e.g., from the example communication interface 202 of FIG. 2) including a portion of media monitoring data (e.g., the example media monitoring data 108 of FIG. 1) to be processed. In some such examples, the internet message may additionally include instructions for processing the data. In such examples, control proceeds to block 508. In alternative examples, the example network interface 302 may not receive a request for data processing from the example meter 104. In such examples, control proceeds to block 516.

At block 508, the example IoT device 118,120 receives an assigned portion of media monitoring data from the mobile device 102. For example, the example network interface 302 may receive an internet message from the meter 104 including the assigned portion of the media monitoring data (e.g., one or more of the example data portions 110-116 of FIG. 1). In such examples, the assigned portion of the media monitoring data is stored in the example database 304. In some such examples, the assigned portion of the media monitoring data is determined at the meter 104 when a monitoring data allocation is calculated.

At block 510, the example IoT device 118,120 processes the assigned portion of the media monitoring data. For example, the example media data handler 308 may access the assigned portion (e.g., one or more of the example data portions 110-116 of FIG. 1) stored in the database 304 and process the assigned portion. In some such examples, the example media data handler 308 processes the assigned portion according to instructions transmitted by the example meter 104 and received by the network interface 302.

At block 512, the example IoT device 118,120 transmits the processed assigned portion to a collection server to be combined with processed remaining media monitoring data. For example, the example network interface 302 may transmit the processed assigned portion (e.g., one or more of the example processed data portions 110-116 of FIG. 1) to the example collection server 140 when the example media data handler 308 has finished processing the assigned portion. In some such examples, the example network interface 302 may transmit a device identifier (ID), such as the example device ID 106 of FIG. 1, with the assigned portion. The device ID 106 may be used by the example collection server 140 in combining the processed media monitoring data portions.

At block 514, the example IoT device 118,120 determines whether a new assigned portion of media monitoring data is received. For example, the example network interface 302 may receive another assigned portion of media monitoring data (e.g., one of the example data portions 110-116) from the example meter 104. In such examples, control returns to block 510 in which the new assigned portion is processed (e.g., by the example media data handler 308). In alternative examples, the example network interface 302 does not receive another assigned portion of media monitoring data, and control proceeds to block 516.

At block 516, the example IoT device 118,120 determines whether a new request for resource information is received. For example, the example network interface 302 may receive a message from the example meter 104 for resource information of the example IoT device 118,120. In such examples, control proceeds to block 504 in which the example IoT device 118,120 transmits the resource information to the mobile device 102. In alternative examples, the example IoT device 118,120 does not receive a new request for resource information. In such examples, the example program 500 concludes.

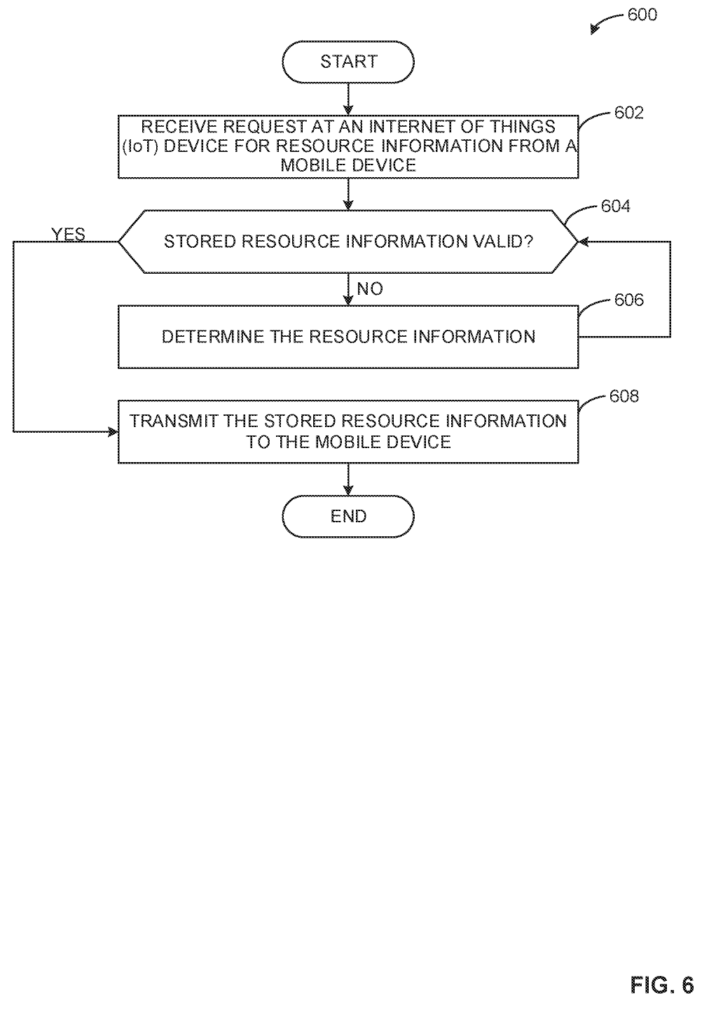

FIG. 6 is a flow diagram of example machine readable instructions which may be executed by the example Internet of Things (IoT) device 118,120 to acquire and transmit resource information of the IoT device 118,120. The example program 600 begins at block 602 when the example IoT device 118,120 receives a request for resource information from the example meter 104. For example, the example network interface 302 of FIG. 3 may receive a request from the example communication interface 202 of FIG. 2. In such examples, the network interface 302 may forward the request to the example resource determiner 306.

At block 604, the example IoT device 118,120 determines whether the resource information is valid. For example, the resource determiner 306 may determine that the resource information of the IoT device 118,120 already stored in the example database 304 is valid (e.g., up-to-date, complete, etc.). In such examples, control proceeds to block 616 and the resource information is transmitted to the meter 104 by the network interface 302. In alternative examples, the resource determiner 306 may determine that the resource information stored in the database 304 is invalid (e.g., lost, incorrect, incomplete, etc.). In such examples, control proceeds to block 606.

At block 606, the example IoT device 118,120 determines the resource information. For example, the resource determiner 306 may determine current resource information of the IoT device 118,120 (i.e., update the resource information). For example, the resource determiner 306 may determine data usage information, memory usage information, and/or processor characteristics (e.g., clock speed, bus speed, etc.). Additionally or alternatively, the resource determiner may determine a media access control (MAC) address, an internet protocol (IP) address, a service set identifier (SSID), a vendor identifier (VID), etc. The resource determiner 306 may then update the resource information in the database 304. In the example program, control returns to block 604 to determine whether the updated stored resource information is valid.

At block 608, the example IoT device 118,120 transmits the stored resource information to the mobile device 102. For example, the network interface 302 may transmit the stored resource information in an Internet message to the example mobile device 102. When the stored resource information is transmitted, the example program 600 concludes until a new request for resource information is received by the example IoT device 118,120.

FIG. 7 is a flow diagram of example machine readable instructions which may be executed to implement the example meter 104 to recover a forgotten, lost, etc. device identifier. The example program 700 begins at block 702 when the example meter 104 queries a network for local devices. For example, the meter 104 executing on the mobile device 102 may detect local devices via a network such as the example Bluetooth network 122 of FIG. 1. In some examples, the meter 104 may execute on a device other than a mobile device (e.g., a stationary device such as a desktop computer, television, etc.)

At block 704, the example meter 104 transmits a request for storage of a mobile device identifier (ID) to the local devices. For example, the communication interface 202 of FIG. 2 may transmit a request to the example IoT device 118,120 of FIGS. 2-3 asking the IoT device 118,120 to store the example device identifier (ID) 106 associated with the mobile device 102. In some examples, the meter 104 may transmit multiple requests to multiple network devices for storage of the device ID 106 associated with the mobile device 102.

At block 706, the example meter 104 receives response(s) from the local device(s). For example, the meter 104 may receive a response from the IoT device 118,120 to notify the meter 104 that the IoT device 118,120 will store the device ID 106. In some examples, the meter 104 may receive responses from multiple devices (e.g., the first IoT device 118 of FIG. 1, the third IoT device 152 of FIG. 1, etc.).

At block 708, the example meter 104 transmits the mobile device ID to the local devices to be stored. For example, the meter 104, upon receiving a response from the local device or devices, may transmit the device ID 106 associated with the mobile device 102 to each of the local devices (e.g., the first IoT device 118, the third IoT device 152, etc.) for storage at the local devices.

At block 710, the example meter 104 determines whether a portion of data is to be transmitted to the local device(s). For example, the meter 104 may assign a portion of data (e.g., one of the data portions 110-116 of FIG. 1) to be transmitted to a local device (e.g., the first IoT device 118) according to the example monitoring data allocation. In such an example, control proceeds to block 712. If, on the other hand, no portion of data (e.g., none of the data portions 110-116) is to be transmitted to the local device, control proceeds to block 720.

At block 712, the example meter 104 determines whether the mobile device ID is known. For example, the meter 104 may determine that the device ID 106 associated with the mobile device 102 has been forgotten (e.g., erased by privacy protection agents, user actions, other malicious agents running on the mobile device, etc.). In such examples, control proceeds to block 714. In other examples, the device ID 106 is known (e.g., a valid device ID is stored in the example database 204 of FIG. 2), and control proceeds to block 718.

At block 714, the example meter 104 transmits a request to a collection server for the mobile device ID. For example, the communication interface 202 may transmit an Internet message to the example collection server 140 of FIG. 1 to request the device ID 106 associated with the mobile device 102. In some examples, the request includes information associated with the meter 104 (e.g., a serial number).

At block 716, the example meter 104 receives the mobile device ID. For example, the communication interface 202 may receive a response to the request transmitted at block 714 that includes the device ID 106 associated with the mobile device 102. In some examples, the meter 104 may store the device ID 106 associated with the mobile device 102 in the database 204.

At block 720, the example meter 104 determines whether to continue metering the mobile device. For example, the meter 104 may determine to continue metering the mobile device 102 and collecting media monitoring data (e.g., the media monitoring data 108 of FIG. 1). In such an example, control returns to block 702 and the meter 104 queries the network (e.g., Bluetooth network 122) for local devices. In other examples, the meter 104 may determine to stop metering the mobile device 102, and the example program 700 concludes.

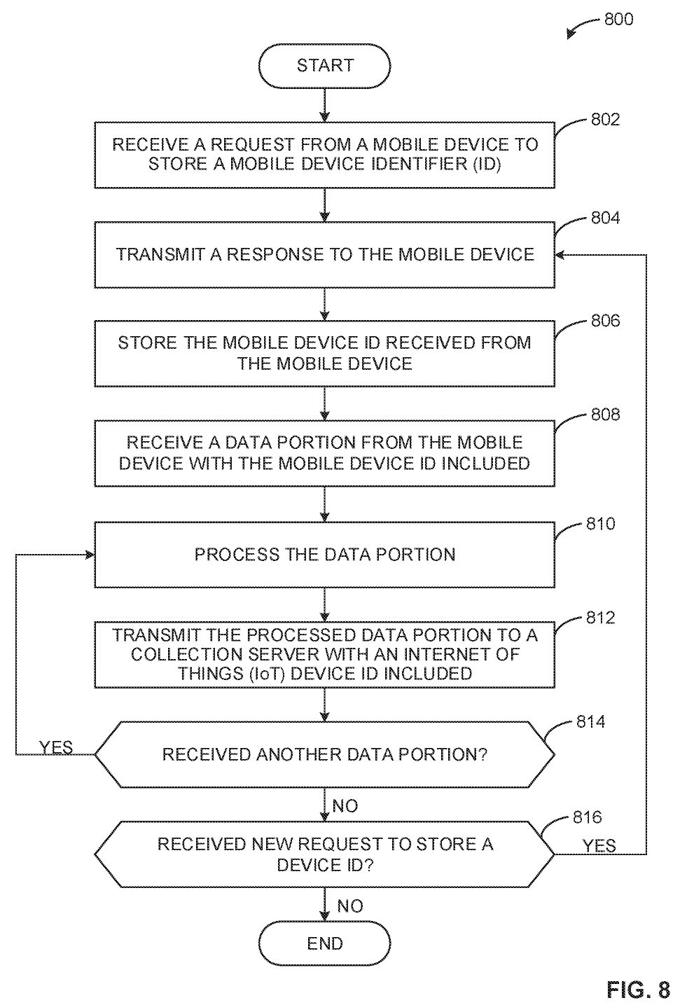

FIG. 8 is a flow diagram of example machine readable instructions which may be executed to implement the example IoT device 118,120 of FIGS. 2-3 to store and transmit a mobile device identifier (ID). The example program 800 begins at block 802 when the example IoT device 118,120 receives a request to store the mobile device ID. For example, the example network interface 302 of FIG. 3 may receive a request via a network (e.g., the example Bluetooth network 122 of FIG. 1) from the example communication interface 202 of FIG. 2 to store the example device ID 106 associated with the mobile device 102 of FIG. 1.

At block 804, the example IoT device 118,120 transmits a response to the mobile device. For example, the network interface 302 may transmit a response notifying the example meter 104 of FIGS. 1-3 that the IoT device 118,120 is capable of storing the device ID 106 associated with the mobile device 102.

At block 806, the example IoT device 118,120 stores the mobile device ID received from the mobile device. For example, the network interface 302 may receive an Internet message that includes the device ID 106 associated with the mobile device 102. In such an example, the device ID 106 may be stored in the example database 304 of FIG. 3.

At block 808, the example IoT device 118,120 receives a data portion from the mobile device with the mobile device ID included. For example, the IoT device 118,120 may receive one of the example data portions 110-116 of FIG. 1 from the meter 104 that includes the device ID 106 associated with the mobile device 102. In some examples, the example data portion (e.g., one of the data portions 110-116) may be stored in the database 304.

At block 810, the example IoT device 118,120 processes the data portion. For example, the example media data handler 308 of FIG. 3 may process the data portion (e.g., one of the data portions 110-116) received from the meter 104. In some examples, the processed data portion (e.g., one of the processed data portions 126-132) may be stored in the database 304.

At block 812, the example IoT device 118,120 transmits the processed data portion to a collection server with an Internet of Things (IoT) device ID included. For example, after the data portion has been processed, the network interface 302 may transmit the processed data portion (e.g., one of the processed data portions 126-132) to the example collection server 140 of FIG. 1 in an Internet message that includes a device ID (e.g., the device ID 106) associated with the IoT device 118,120. In such examples, the transmitted processed portion includes the device ID 106 associated with the IoT device 118,120 and the device ID 106 associated the mobile device 102.

At block 814, the example IoT device 118,120 determines whether another data portion has been received. For example, if the network interface 302 receives an additional data portion (e.g., one of the data portions 110-116), control returns to block 810. In other examples, the IoT device 118,120 may not receive another data portion, and control proceeds to block 816.

At block 816, the example IoT device 118,120 determines whether a new request to store a device ID has been received. For example, the network interface 302 may receive a new request from the meter 104 asking to store a device ID (e.g., the device ID 106 associated with the mobile device 102) at the IoT device 118,120. In such an example, control proceeds to block 804. In other examples, the IoT device 118,120 may not receive another request, and the program concludes.

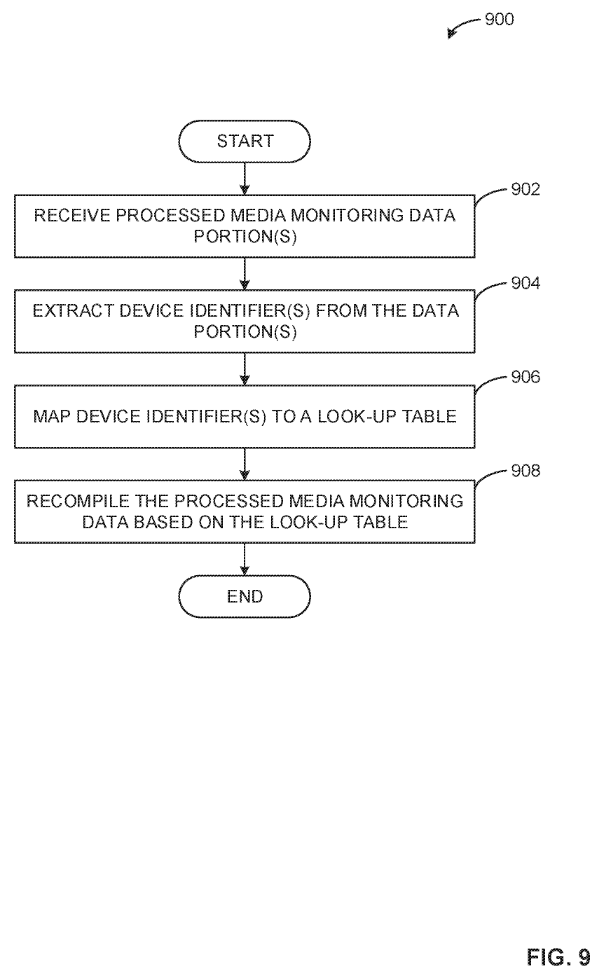

FIG. 9 is a flow diagram of example machine readable instructions which may be executed to implement the example collection server 140 to receive and combine processed media monitoring data. The example program 900 begins at block 902 when the example collection server 140 receives processed media monitoring data portion(s). For example, the example data interface 142 may receive internet messages from the example IoT device 118,120 (i.e., from the example network interface 302 of FIG. 3) and/or the example mobile device 102 (i.e., from the example communication interface 202 of FIG. 2). In such examples, the Internet messages may include processed assigned data portions (e.g., the example processed data portions 126-132) and/or device identifiers (IDs), such as the example device ID 106 of. In some such examples, the example collection server 140 may store the information included in the internet message (e.g., the example processed assigned data portions 126-132, the device ID 106, etc.) in the example database 144.

At block 904, the example collection server 140 extracts device identifier(s) from the data portion(s). For example, the example mapping tool 146 may extract example device IDs 106 corresponding to the example processed assigned data portions 126-132. In some such examples, the example mapping tool 146 may store the extracted device IDs 106 in the example database 144.

At block 906, the example collection server 140 maps the device identifier(s) to a look-up table. For example, the example mapping tool 146 may map the device IDs 106 to the example map 150 of FIG. 1. In some examples, the example map 150 is a look-up table. In some examples, the example map 150 is transmitted to the example collection server 140 by the example meter 104. In some examples, the example map 150 is transmitted from the mobile device 102 with the processed media monitoring data (e.g., the example second and fourth processed data portions 128 and 132).

At block 908, the example collection server 140 recompiles the processed media monitoring data based on the look-up table. For example, the mapping tool 146 may utilize the map 150 and the extracted device IDs 106 to recompile the processed media monitoring data portions (e.g., the example processed data portions 126-132) into the example processed media monitoring data 148. In some such examples, the processed media monitoring data 148 is structured identically to the example media monitoring data 108. When the processed media monitoring data 148 has been recompiled, the example program 900 concludes.

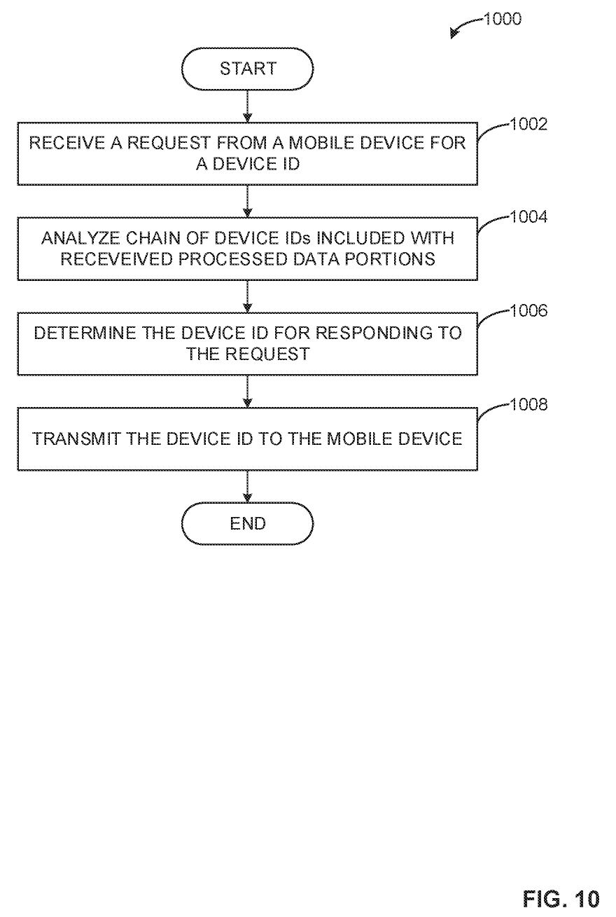

FIG. 10 is a flow diagram of example machine readable instructions which may be executed by the example collection server 140 to acquire and transmit a device identifier (ID) (or any other identifier, such as a panelist identifier, identification marker, etc.) associated with a mobile device. At block 1002, the example collection server 140 receives a request from a mobile device for a device ID. For example, the example data interface 142 of FIG. 1 may receive a request from the example meter 104 for a device ID, such as the device ID 106 of FIG. 1, associated with the mobile device 102.

At block 1004, the example collection server 140 analyzes a chain of device IDs included with received processed data portions. For example, the data interface 142 may receive processed data portions, such as the example processed data portions 126-132 of FIG. 1, from the meter 104, the first IoT device 118, the second IoT device 120, etc. In some examples, the device ID 106 associated with each device is transmitted with the processed data portion. In some such examples, the processed data portion includes multiple device IDs 106. For example, a data portion (e.g., one of the example data portions 110-116) may be transmitted from the mobile device 102 to the first IoT device 118 with the device ID 106 associated with the mobile device 102 included. The data portion may then be transmitted from the first IoT device 118 to the collection server 140 with the device ID 106 of the first IoT device 118 added, thereby including two device IDs. The collection server 140 may therefore analyze the two device IDs (i.e., the chain of device IDs) included with the processed data portion.

At block 1006, the example collection server 140 determines the device ID for responding to the request. For example, the collection server 140 may apply a heuristic method that determines the device ID 106 associated with the mobile device 102 using a consensus of device IDs 106. For example, the collection server 140 may receive processed data portions from multiple devices (e.g., the first IoT device 118, the second IoT device 120, and the mobile device 102). In such an example, the collection server 140 may determine the device ID 106 associated with the mobile device 102 based on the device ID 106 included with each of the processed data portions (e.g., one or more of the processed data portions 126-132). For example, the collection server 140 may determine that the device ID 106 that occurs most frequently as the first device ID 106 in the chain of device IDs (e.g., first attached chronologically) is to be the device ID 106 associated with the mobile device 102. In other examples, a different heuristic method may be used to determine the device ID 106 associated with the mobile device 102.

At block 1008, the example collection server 140 transmits the device ID to the mobile device 102. For example, the data interface 142 may transmit the device ID 106 associated with the mobile device 102 determined at block 1006 to the meter 104 of FIGS. 1-3. When the device ID 106 has been transmitted to the meter 104, the example program 1000 concludes.

As mentioned above, the example processes of FIGS. 4-10 may be implemented using coded instructions (e.g., computer and/or machine readable instructions) stored on a non-transitory computer and/or machine readable medium such as a hard disk drive, a flash memory, a read-only memory, a CD, a DVD, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open ended in the same manner as the term “comprising” and “including” are open ended.

FIG. 11 is a block diagram of an example processor platform 1100 capable of executing the instructions of FIGS. 4 and 7 to implement the meter 104 of FIGS. 1-3. The processor platform 1100 can be, for example, a server, a mobile device (e.g., a cell phone, a smart phone, a tablet, etc.), or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors or controllers from any desired family or manufacturer. The hardware processor may be a semiconductor based (e.g., silicon based) device. In this example, the processor 1112 implements the example data collector 206, the example task scheduler 208, the example Internet of Things (IoT) identifier 210, the example resource analyzer 212, the example data allocator 214, the example allocation evaluator 216, and the example media data processor 218.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), and/or a peripheral component interconnect (PCI) express interface. The interface circuit 1120 implements the example communication interface 202.

In the illustrated example, one or more input devices 1122 are connected to the interface circuit 1120. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1120 of the illustrated example, thus, typically includes a graphics driver card, a graphics driver chip, and/or a graphics driver processor.

The interface circuit 1120 of the illustrated example also includes a communication device such as a transmitter, a receiver, a transceiver, a modem and/or network interface card to facilitate exchange of data with external machines (e.g., computing devices of any kind) via a network 1126 (e.g., an Ethernet connection, a digital subscriber line (DSL), a telephone line, coaxial cable, a cellular telephone system, etc.). The network implements the example network 138 of FIG. 1.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and DVD drives.

The coded instructions 1132 of FIGS. 4 and 7 may be stored in the mass storage device 1128, in the volatile memory 1114, in the non-volatile memory 1116, and/or on a removable non-transitory computer readable storage medium such as a CD or DVD.

FIG. 12 is a block diagram of an example processor platform 1200 capable of executing the instructions of FIGS. 5-6 and 8 to implement the IoT device 118,120 of FIGS. 1-3. The processor platform 1200 can be, for example, a server, a personal computer, a mobile device (e.g., a cell phone, a smart phone, a tablet, etc.), a personal digital assistant (PDA), an Internet appliance, a DVD player, a CD player, a digital video recorder, a Blu-ray player, a gaming console, a personal video recorder, a set top box, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors or controllers from any desired family or manufacturer. The hardware processor may be a semiconductor based (e.g., silicon based) device. In this example, the processor 1212 implements the example resource determiner 306 and the example media data handler 308.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), and/or a peripheral component interconnect (PCI) express interface. The interface circuit 1220 implements the example network interface 302.

In the illustrated example, one or more input devices 1222 are connected to the interface circuit 1220. The input device(s) 1222 permit(s) a user to enter data and/or commands into the processor 1212. The input device(s) can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuit 920 of the illustrated example. The output devices 1224 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1220 of the illustrated example, thus, typically includes a graphics driver card, a graphics driver chip, and/or a graphics driver processor.

The interface circuit 1220 of the illustrated example also includes a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.). The network implements the example network 138 of FIG. 1.

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, redundant array of independent disks (RAID) systems, and DVD drives.

The coded instructions 1232 of FIGS. 5-6 and 8 may be stored in the mass storage device 1228, in the volatile memory 1214, in the non-volatile memory 1216, and/or on a removable non-transitory computer readable storage medium such as a CD or DVD.

From the foregoing, it will be appreciated that the above disclosed methods, apparatus, and articles of manufacture create an opportunistic network of IoT collaboration agents to collect data from mobile devices. The collaboration agents (e.g., IoT devices such as those disclosed herein) may be assigned portions of media monitoring data by the mobile device. It will be appreciated that the portions of the media monitoring data are assigned by the meter based on the resources available to each IoT device, and that each IoT device includes software to properly receive, process, and transmit the media monitoring data.

By implementing the above disclosed methods, apparatus, and articles of manufacture, negative effects of the collection of media monitoring data on the mobile device and the user of the mobile device may be mitigated or eliminated. The negative effects of current collection methods on the mobile device include the high demand on memory and data usage of the mobile device, the reduced battery life of the mobile device battery due (i.e., from processing and transmitting media monitoring data), and reduction in mobile device speed. Some example disclosed herein allow the storage of identifying information within a network of devices to allow later retrieval in case a device loses access to the identifying information. Some examples disclosed herein allow the meter to reduce the amount of memory and data used by the mobile device to process and transmit the media monitoring data. Further, some disclosed examples increase the battery life of the mobile device (i.e., the mobile device will last longer on a single charge) by requiring less power to operate the mobile device meter. In some such disclosed examples, the IoT devices used to process portions of the media monitoring data have a constant power supply and therefore are not limited by a battery life as are the mobile devices. Further still, some disclosed examples increase a user experience for a mobile device user by increasing speed and battery life of the mobile device.

Although certain example methods, apparatus, and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A first media monitoring device comprising:
means for obtaining, at the first media monitoring device, resource information from a second device, the resource information including processing power and available memory of the second device;
means for assigning a first portion of media monitoring data to the first media monitoring device and a second portion of the media monitoring data to the second device according to a monitoring data allocation, the monitoring data allocation determined based on the media monitoring data and the resource information, the media monitoring data including data corresponding to media accessed by a user associated with the first media monitoring device;
means for processing the first portion at the first media monitoring device; and
means for transmitting to transmit:
the second portion to the second device for processing and transmission to a collection server; and
the processed first portion to the collection server for combining with the processed second portion.

2. The apparatus of claim 1, wherein the means for obtaining further obtains the media monitoring data.

3. The apparatus of claim 1, wherein the resource information further includes data storage information and configuration information of the second device.

4. (canceled)

5. The apparatus of claim 1, wherein the collection server combines the processed first portion and the processed second portion based on a first device identifier and a second device identifier, the device identifiers obtained by the means for obtaining.

6. The apparatus of claim 1, wherein the collection server combines the processed first portion and the processed second portion using a mapping tool, the mapping tool including a look-up table.

7. (canceled)

8. The apparatus of claim 1, wherein the means for assigning further includes means for evaluating the first portion and the second portion based on predetermined criteria, the means for evaluating to recalculate the first portion and the second portion when the predetermined criteria are not met.

9. A non-transitory computer readable storage medium comprising instructions which, when executed, cause a first media monitoring device to at least:
transmit, from the first media monitoring device, a request to a second device for resource information, the resource information including processing power and available memory of the second device;
determine, at the first media monitoring device, a first portion of media monitoring data assigned to the first media monitoring device and a second portion of the media monitoring data assigned to a second device according to a monitoring data allocation, the monitoring data allocation based on the media monitoring data and the resource information, the media monitoring data including data corresponding to media accessed by a user associated with the first media monitoring device;
transmit, from the first media monitoring device, the second portion to the second device to be processed and transmitted to a collection server;
process the first portion at the first media monitoring device; and
transmit the processed first portion to the collection server to be combined with the processed second portion.

10. The non-transitory computer readable storage medium of claim 9, wherein the media monitoring data is obtained by a meter executing on the first media monitoring device.

11. The non-transitory computer readable storage medium of claim 9, wherein the resource information further includes data storage informational and configuration information of the second device.

12. (canceled)

13. The non-transitory computer readable storage medium of claim 9, wherein the collection server combines the processed first portion and the processed second portion based on a first device identifier and a second device identifier, the device identifiers transmitted to the collection server by the first media monitoring device.

14. The non-transitory computer readable storage medium of claim 9, wherein the collection server further includes a mapping tool to combine the processed first portion and the processed second portion, the mapping tool including a look-up table.

15. (canceled)

16. The non-transitory computer readable storage medium of claim 9, further including evaluating the first portion and the second portion based on predetermined criteria and recalculating the first portion and the second portion when the predetermined criteria are not met.

17. A system comprising:
a first media monitoring device to
determine a first portion of media monitoring data and a second portion of the media monitoring data according to a monitoring data allocation, the monitoring data allocation determined based on the media monitoring data and resource information, the media monitoring data including data corresponding to media accessed by a user associated with the first media monitoring device;
process the first portion of media monitoring data; and
transmit the processed first portion of media monitoring data;
a second device to
transmit the resource information to the first media monitoring device, the resource information including processing power and available memory of the second device;
process the second portion of the media monitoring data assigned by the first media monitoring device; and
transmit the processed second portion; and
a collection server to combine the processed first portion transmitted by the first media monitoring device and the processed second portion transmitted by the second device.

18. The system of claim 17, wherein the media monitoring data is obtained by a meter executing on the first media monitoring device.

19. The system of claim 17, wherein the resource information further includes data storage information and configuration information of the second device.

20-23. (canceled)

24. The system of claim 17, wherein first media monitoring device evaluates the first portion and the second portion based on predetermined criteria and recalculates the first portion and the second portion when the predetermined criteria are not met.

25. The system of claim 17, wherein the second device includes a software development kit to process and transmit the second portion, the software development kit previously installed by a manufacturer of the second device.

26. A system as defined in claim 17, wherein the first media monitoring device is further to transmit the second portion and a first device identifier identifying the first media monitoring device to the second device and the second device is further to transmit the processed second portion, the first device identifier, and a second device identifier identifying the second device to the collection server.

27. A system as defined in claim 26, wherein the first media monitoring device is further to request the first device identifier from the collection server and the collection server is further to:
analyze a plurality of messages including device identifiers to determine the first device identifier; and
transmit the first identifier to the first media monitoring device.

28. A system as defined in claim 27, wherein the collection server is further to determine the first identifier based on a frequency of the first identifier occurring in the plurality of messages.
